(19) United States
(12) Patent Application Publication
(10) Pub. No.: US 2023/0128514 A1
(43) Pub. Date: Apr. 27, 2023

(54) Versatile ratchet socket organizer

(71) Applicant: Smail Errimi, Montreal (CA)

(72) Inventor: Smail Errimi, Montreal (CA)

(21) Appl. No.: 17/479,852

(22) Filed: Sep. 20, 2021

(30) Foreign Application Priority Data
Sep. 23, 2020 (GB) 2015047.0

(51) Int. Cl. B25H 3/00

(52) U.S. Cl. CPC B25H 3/003

(57) ABSTRACT

A ratchet socket organizer is provided, having a base upon which rotates a circular socket holder. In the center of the socket holder is a magnetized dish fixedly attached to the base and used for collecting small parts such as nuts, bolts, and washers. The base has magnetized pads on its underside so as to stick to the side of metallic objects such as tool chests. Also, there is a handle and belt clip so that a user can carry it along hands free. The socket sizes within the socket holder are clearly identified for organization. Both short and deep well sockets are grouped together.

### CROSS-REFERENCE TO RELATED APPLICATIONS

The present application claims priority to United Kingdom Patent Application serial number 2015047.0, filed on Sep. 23, 2020 entitled “Versatile ratchet socket organizer”, the disclosure of which is hereby incorporated in its entirety at least by reference.

### BACKGROUND OF THE INVENTION

### 1. Field of the Invention

The present invention relates generally to hand tool accessories but more particularly to a versatile ratchet socket organizer.

### 2. Description of Related Art

Tools are very useful but only if we can easily find them or access them in an easy and timely fashion. This is especially important when it comes to small components such as sockets for a ratchet set. In most instances, the socket sets usually come in a nice box with the ratchet handle and related accessories. Although the box set looks great, it is not always practical for everyday use. Consequently, a versatile ratchet socket organizer is provided.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a versatile ratchet socket organizer. In order to do so, a ratchet socket organizer is provided, comprising a base section; an upper section attached to the base section and configured to rotate within the base section; a plurality of socket wells positioned on the upper section, wherein the plurality of sockets are configured to retain a plurality of sockets.

In another aspect of the invention, a ratchet socket organizer is provided, comprising a cylindrical base section having a bottom surface and circumferential collar extending perpendicularly from the bottom surface; a cavity within the bottom surface, wherein the cavity is configured to retain a first magnet configured to magnetically attach the ratchet socket organizer to a metallic surface; a cylindrical upper section attached to the cylindrical base section and configured to rotate within the circumferential collar of the base section via a bearing member; and, a plurality of socket wells positioned on the upper section, wherein the plurality of sockets are arranged in at least one circle and configured to retain a plurality of sockets.

In one embodiment, the cylindrical base includes a centrally positioned circular channel within the base section, and a ring centrally positioned on the upper section configured and sized to fit into the circular channel. In another embodiment, the circular channel is positioned within an attachment member on the base section, wherein the bearing member is positioned between the attachment member an underside surface of the upper section. In another embodiment, a flanged connector member positioned within the ring of the upper section and attached to the attachment member facilitating a rotational attachment of the upper section and the base section is provided. In yet another embodiment, the flange connecting member is adhesively attached to the attachment member. In one embodiment, the upper section includes a circumferential wall extending perpendicularly from a second bottom surface. In one embodiment, the upper section includes a dish configured to retain small metallic objects. In another embodiment, the dish is constructed of ferrous material. In another embodiment, a toroid magnet is located underneath the dish making the small metallic objects cling to the dish regardless of the orientation of the ratchet socket organizer. In one embodiment, a bottom surface of each of the plurality of socket wells are lined with a magnetizing material configured to magnetically couple to the plurality of sockets. In one embodiment, a handle extends from the circumferential collar of the base section. In one embodiment, the cavity is within a magnet holding portion formed from the base section.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is an exploded cutaway view of a ratchet socket organizer according to an embodiment of the present invention;

FIG. 2A is a side, bottom isometric view of the ratchet socket organizer according to an embodiment of the present invention;

FIG. 2B is an isometric view of a base section of the ratchet socket organizer according to an embodiment of the present invention;

FIG. 3A is a top view of the ratchet socket organizer according to an embodiment of the present invention;

FIG. 3B is a side view of the ratchet socket organizer according to an embodiment of the present invention; and,

FIG. 4 is an isometric view of the ratchet socket organizer magnetically attached to a metallic tool chest according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a ratchet socket organizer.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

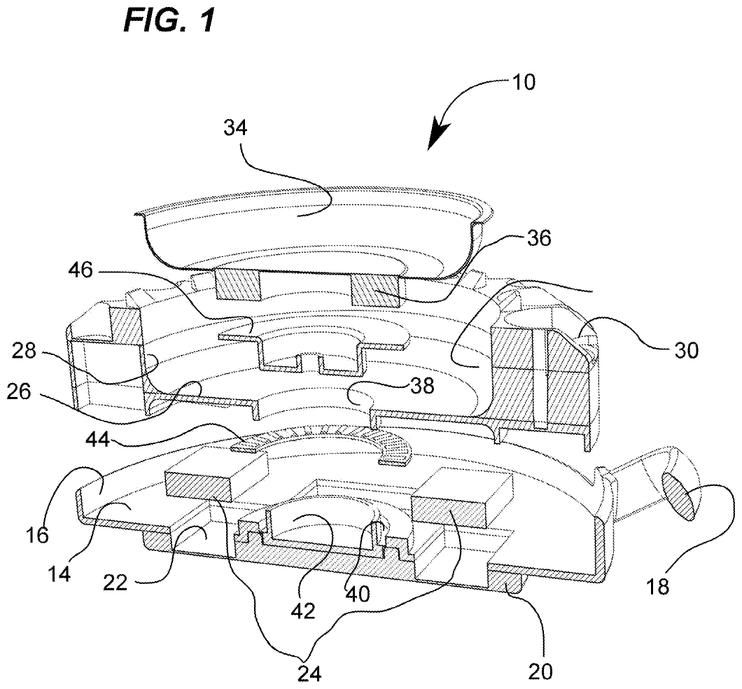

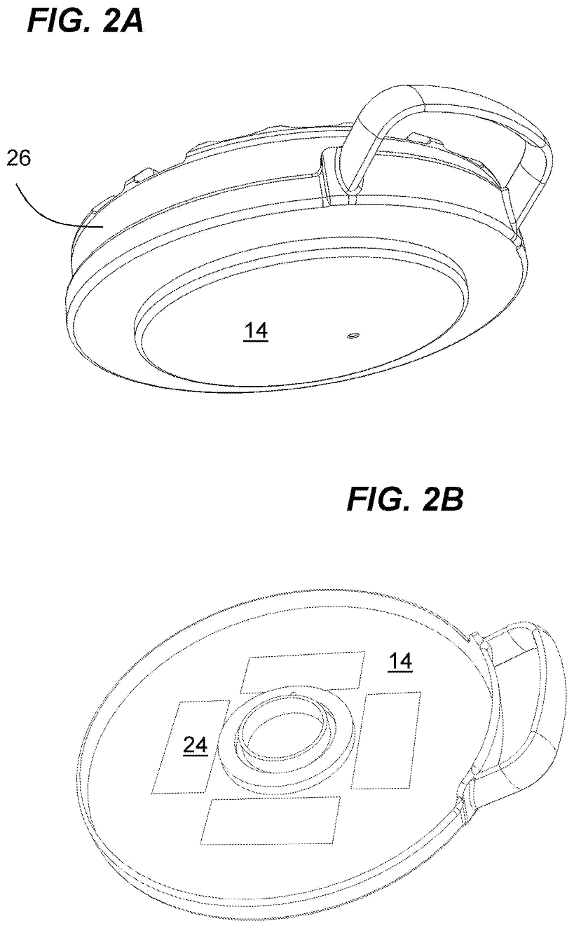

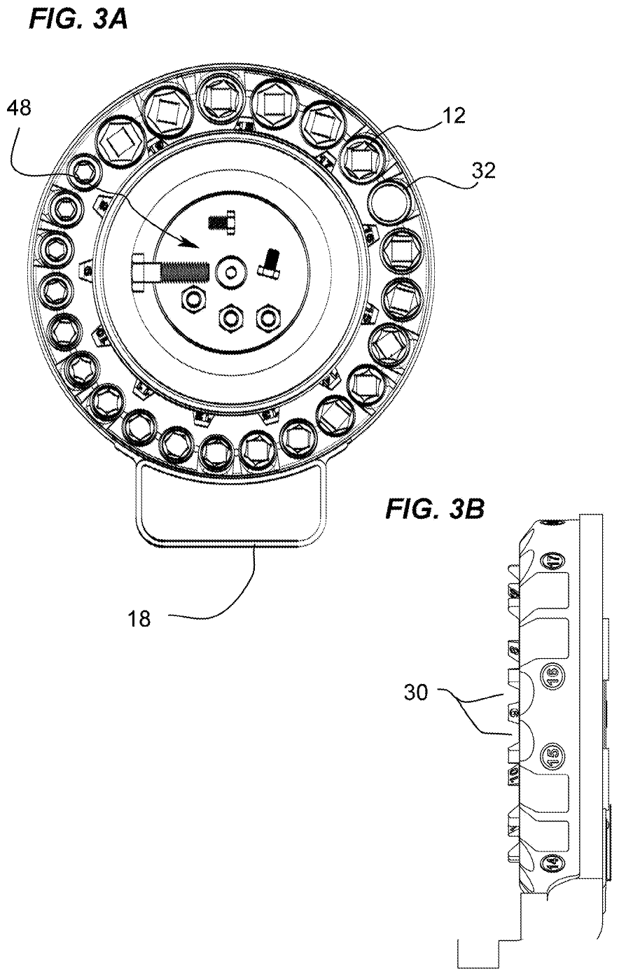

Referring now to any of the accompanying FIGS. 1-4, a ratchet socket organizer 10 is illustrated. In one embodiment, the ratchet socket organizer comprises a cylindrical base section 14 having a plurality of magnets 24 configured to be positioned into a plurality of cavities 22, wherein the cavities 22 are sized and shaped to retain the magnets 24. In one embodiment, the cavities 22 are supported via a magnet holding portion 20 formed from the base section 14. Advantageously, the magnets 24 are not visible from the outside of the organizer 10 as seen in FIG. 2A, and the magnets 24 are configured to enable the organizer 10 to attach to magnetic surfaces. This will be discussed in further details below.

In one embodiment, the base section 14 further comprises a circumferential side surface or collar 16 extending perpendicularly from the base section 14 and a circular channel 40 centrally positioned within the base section 14. In one embodiment, an attachment member 42 is provided within the circular channel 40 at a center portion of the base section 14. The collar 16 and attachment member are configured to facilitate the rotational attachment of an upper section 26 of the organizer 10.

In one embodiment, the upper section 26 is cylindrically shaped having a diameter less than the diameter of the base section 14, such that the upper section 26 is configured to rotate within the collar 16 of the base section, i.e. the outer side wall of the upper section is within the inner wall of the collar 16. In one embodiment, an inner ring or flange 38 is formed within a center portion of the bottom surface of the upper section 26. The inner ring or flange 38 is shaped and sized to fit into the circular channel 40 of the base section 14 and is frictionally connected onto the outer diameter of the attachment member 42. A circular bearing 44 is positioned between the top of the circular channel 40 and the underside of the upper section 26, wherein the circular bearing 44 is configured to enable the rotation of the upper section 26 relative the base section 14. In one embodiment, a flange connecting member 46 ensures a secure connection between the upper section 26 and the base section 14 via the rotational and attachment components (38, 40, 42, and 44). In one embodiment, the flange connecting member 46 is adhesively attached to the attachment member 42.

In one embodiment, the upper section 14 comprises a circumferential wall 28 extending generally perpendicular from the bottom surface of the upper section 24. In one embodiment, a generally cylindrical dish 34 is configured to sit within the circumferential wall 28. Advantageously, the dish 34 is comprised of a ferrous material such that a toroid magnet 36 located underneath the dish 34 is configured to make nuts, bolts, washers and other metallic objects 48 cling to the dish 34 no matter its orientation. For example, even if the organizer 10 is held or positioned in an upside down orientation, small metallic objects 48 are configured to be collected at the center of the dish 34.

In one embodiment, between the circumferential wall 28 and the outer dimeter surface of the upper section 24 is a plurality of socket wells 30 configured to receive a plurality of sockets 12. Each socket well 30 is sized to receive a different sized socket 12, wherein the sizing may be in metric and/or imperial units, general identified by millimeters and inches respectively. In some embodiments, insignia or markings may be provided near each socket well such that the user knows the size of each socket and the correct socket well to place the socket after use. The overall size of the organizer 10 may vary and such the number of socket wells 30 may vary. In one embodiment, each of the socket wells are lined with magnetizing material 32, wherein the magnetizing material 32 is configured to align and retain each socket within its respective socket well regardless of the orientation of the organizer. In one embodiment, the bottom surface of the socket wells are lined with the magnetizing material 32.

In alternative embodiments, more than one concentric circle of socket wells may be provided enabling more sockets to be organized. In this instance, short and deep well sockets may be separated into each circle of socket wells for better organization. In other embodiments, the short and deep well sockets may be grouped together. Likewise, metric and imperial sockets may be organized together and be positioned each in a different concentric circle of socket wells. One skilled in the art may recognize and appreciate many alternative and possibilities of socket organization.

In one embodiment, the base section 14 includes at least one handle 18 projecting from the side surface 16, wherein the handle 18 is configured to enable a user to move or transport the organizer 10 during use. Although not illustrated, in some embodiments, a belt clip is provided enabling a user to carry the organizer 10 without the use of their hands as well known in the art.

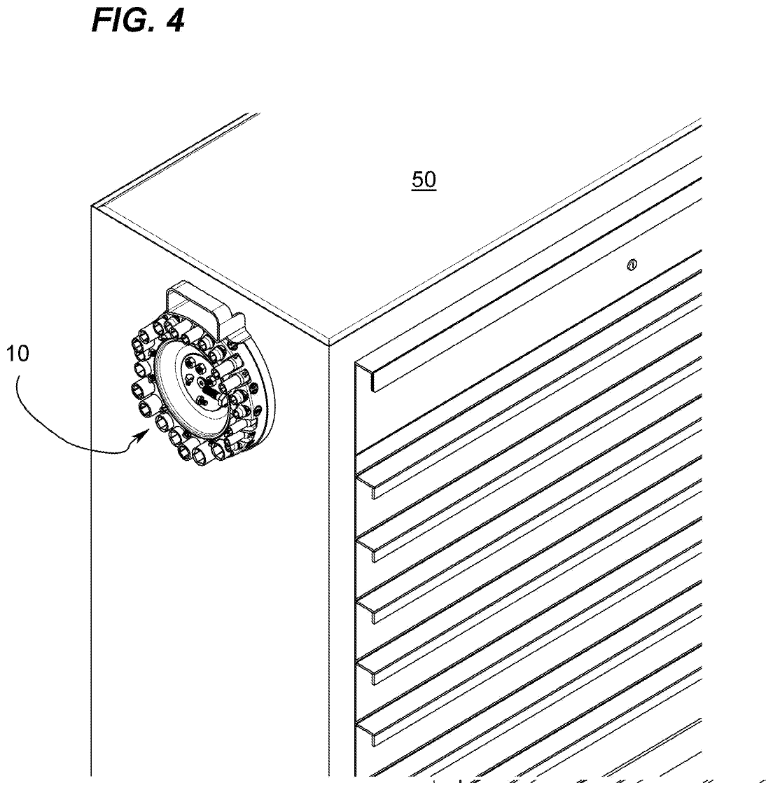

Best seen in FIG. 4, one exemplary embodiment of positioning the ratchet socket organizer 10 on a metallic surface is provided. In this instance, the organizer 10 is positioned in a vertical orientation on a metallic tool chest 50. As previously mentioned, the plurality of magnets 24 within the base section 14 enable the bottom surface of the organizer 10 to magnetically attach to a metallic surface for storage and convenience during use. Further, as previously mentioned, the orientation of the organizer 10 does not matter due to the several magnetic components provided.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, the organizer may be a different shape as long as rotation is enabled between the upper section and base section of the organizer.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A ratchet socket organizer comprising:
a base section;
an upper section attached to the base section and configured to rotate within the base section; and,
a plurality of socket wells positioned on the upper section, wherein the plurality of sockets are configured to retain a plurality of sockets;
a cylindrical base section having a bottom surface and circumferential collar extending perpendicularly from the bottom surface;
a cavity within the bottom surface, wherein the cavity is configured to retain a first magnet configured to magnetically attach the ratchet socket organizer to a metallic surface;
a cylindrical upper section attached to the cylindrical base section and configured to rotate within the circumferential collar of the base section via a bearing member; and
a plurality of socket wells positioned on the upper section, wherein the plurality of sockets are arranged in at least one circle and configured to retain a plurality of sockets.

2. (canceled)

3. The ratchet socket organizer of claim 2, wherein the cylindrical base includes a centrally positioned circular channel within the base section, and a ring centrally positioned on the upper section configured and sized to fit into the circular channel.

4. The ratchet socket organizer of claim 3, wherein the circular channel is positioned within an attachment member on the base section, wherein the bearing member is positioned between the attachment member an underside surface of the upper section.

5. The ratchet socket organizer of claim 4, further comprising a flanged connector member positioned within the ring of the upper section and attached to the attachment member facilitating a rotational attachment of the upper section and the base section.

6. The ratchet socket organizer of claim 5, wherein a flange connecting member is adhesively attached to the attachment member.

7. The ratchet socket organizer of claim 2, wherein the upper section includes a circumferential wall extending perpendicularly from a second bottom surface.

8. The ratchet socket organizer of claim 7, wherein the upper section includes a dish configured to retain small metallic objects.

9. The ratchet socket organizer of claim 8, wherein the dish is constructed of ferrous material.

10. The ratchet socket organizer of claim 9, wherein a toroid magnet is located underneath the dish making the small metallic objects cling to the dish regardless of the orientation of the ratchet socket organizer.

11. The ratchet socket organizer of claim 2, wherein a bottom surface of each of the plurality of socket wells are lined with a magnetizing material configured to magnetically couple to the plurality of sockets.

12. The ratchet socket organizer of claim 2, wherein a handle extends from the circumferential collar of the base section.

13. The ratchet socket organizer of claim 2, wherein the cavity is within a magnet holding portion formed from the base section.
